(19) United States
(12) Patent Application Publication
(10) Pub. No.: US 2012/0284104 A1
(43) Pub. Date: Nov. 8, 2012

(54) USER CUSTOMIZABLE REAL-TIME ONLINE MERCHANT EVENT PLATFORM UTILIZING PRICE VARIATIONS AND ASSOCIATED METHOD FOR INCREASING WEB SITE VISIBILITY

(76) Inventor: Donald Keenan, Wexford, PA (US)

(21) Appl. No.: 13/464,144

(22) Filed: May 4, 2012

Related U.S. Application Data
(60) Provisional application No. 61/518,336, filed on May 4, 2011.

(51) Int. Cl. G06Q 30/02

(52) U.S. Cl. 705/14.23

(57) ABSTRACT

A user customizable, real-time, online merchant event platform utilizes price variations through at least one sales event for increasing website visibility. The platform includes a user interface configured to input: sale item identification, sale event duration for each sale item, a sale item price range, and a frequency distribution identifying the relationship of the price range and the associated sale items and the duration of the associated sales event. The merchant event platform generates a frequency distribution database utilizing the frequency distribution to identify the price of each sale item during the sales event. The merchant event platform includes at least one online web page displaying select sale item indicia, a price range for the sales items, a current price for an associated sale item, purchasing indicia for a sale item configured to facilitate consumer purchase of the associated sale item, and user related advertising indicia.

### RELATED APPLICATIONS

This application claims priority to U.S. provisional patent application Ser. No. 61/518,336 filed May 4, 2011, entitled “Method Involving Real Time Price Variations to Attract Visitors to a Website.”

### BACKGROUND OF THE INVENTION

1. Field of the invention

The present invention relates to a user customizable, real-time, online merchant event platform utilizing price variations and an associated method for increasing website visibility.

2. Background Information

It is stating the obvious to note that the internet and E-commerce have a significant impact in the modern business world. A, now dated, 2008 survey noted that about ¾ of the “larger small firms” (revenues of $5-10 million annually) had a web presence, i.e. a website. Even in 2008, about 17 of 20 mid sized firms had a website. The present numbers are certainly significantly higher across all business sizes.

Within the meaning of this application, the phrases “web presence” or “online presence” have a conventional meaning, namely having a website. A website is a set of related web pages containing content media typically such as text, image, video, audio, and combinations thereof. As known in the art, a website is typically hosted on at least one web server, and is accessible via a network such as the Internet through an Internet address known as a Uniform Resource Locator (URL). An alternative network is a private (or a public) local area network (LAN). All internet based publicly accessible websites collectively constitute the World Wide Web.

Despite the rapid growth of the internet, E-commerce and businesses online presence, many internet based businesses and businesses having a high reliance upon their web presence have failed. According to several sources, more than 90% of all internet business start-ups end in failure within the first 120 days.

One critical aspect for the success of an internet based business, or one relying highly upon their online presence, is website traffic. Website traffic is generally described as a measure of the number of visitors to a website, and represents a quantifiable metric for website effectiveness. The term visibility is used herein as another characteristic of a website that includes consideration of website traffic, together with the amount of time that individual users spend on a website, the number of times users return to a website, and the amount or level which users interact with the website. As an example, two websites may share similer amounts of website traffic but one website may have a higher visibility by having a greater amount of time that individual users spend on the website, or greater number of times they return to the website, or greater amount or level which they interact with the website, or combinations thereof.

One aspect that is often identified as a significant reason for of failed internet businesses is associated failure of the business to conduct targeted promotion. There are many other reasons, of course, some more important that others in each particular instance, but conducting targeted promotions is one consideration that is particularly relevant for the present development. The analysis or question related to targeted promotions is does a business properly promote its products online? A business is successful if it gets continuous flow of targeted traffic and it is axiomatic that getting traffic requires promotion. Promotion generally involves long-term consistent planning and activities designed to inform potential customers about a company's products. A business's promotional activities have been identified as including: creating a clear image and description of a company's products; planning a company's marketing campaigns; finding out appropriate media (including cost and scheduling calendars); planning activities for reaching a company's potential customers; planning the time required for promotional efforts; and planning expenditure required for promotional efforts. For over the last 40 years promotions have emerged to represent the main share of marketing budget for most consumer packaged goods. For a discussion of retailer promotion planning and forecasting see the article by Professor Michael Trusov of UCLA entitled “Retail Promotion Planning: Improving Forecast Accuracy and Interpretability”. Journal of Interactive Marketing Volume 20, number 3-4, 2006. One time honored method for merchants, in both brick and mortar locations (i.e. physical locations) and online websites, to increase consumer traffic is through promotional retail price reductions of merchandise, also known as running sales. The sale is a promotional merchant event or sale event and will typically run for a set period of time or for a fixed number of merchandise units also called sale items. Alternatively, the sales event can use either set points or cutoffs for setting the duration of the sales event. For example, a merchant may offer 20 units of a given sales item at a discount of 50% off of the normal retail price for the following week or until all 20 units are sold with the sale event ending when the with the first set point that is reached.

For additional general sales event background U.S. Pat. No. 6,839,681 disclosing a performance measurement method for sales events. U.S. Pat. No. 6,850,896 discloses a system for managing sales data via the web. U.S. Pat. No. 7,305,352 discloses a system of facilitating sales activities that is of general interest. U.S. Pat. No. 7,542,917 discloses a system for analyzing sales performance. These patents are incorporated herein by reference.

Sales events being a ubiquitous merchant promotion, in both brick and mortar locations and online websites, some sales event promotions have added a certain amount of price variability to the promotional sales event. As a representative example, the discounts offered in a particular promotional sales event may vary from 10% to 80% off of the retail price during that sales event. This price variability during a sales event can greatly increase consumer interest and thus increase traffic, and in the context of online sales events, can greatly increase the website traffic and website visibility of the associated website.

In such variable price sales events there must be a mechanism for determining which discount or price is applicable to which specific consumer sales. While such price variability is helpful for increasing consumer interest and associated traffic in the sales event, this type of sales event can quickly become too complex and unwieldy for the merchants to easily implement such a price variable sales event.

Outside or third party marketing companies often assist merchants in planning and implementing marketing campaigns such as a variable price promotional sales event, and can provide the merchants with a system for managing such marketing events. A system for managing marketing promotional events for merchants can identified as a merchant event platform.

With this background it becomes clear that for online promotional sales events there is a need for a merchant event platform utilizing price variations in the sales events and an associated method for increasing website visibility that provide a promotional sales event management solution that is cost effective and easy for the merchants to implement.

### SUMMARY OF THE INVENTION

The present invention addresses the deficiencies of the prior art and provides a merchant event platform utilizing price variations in the sales events and an associated method for increasing website visibility that provide a promotional sales event management solution that is cost effective and easy for the merchants to implement.

One aspect of this invention is directed to a user customizable, real-time, online merchant event platform utilizing price variations through at least one sales event for increasing website visibility. The merchant event platform includes an online user interface accessible by the user, wherein the user interface is configured to have the user input at least: i) at least one sale item identification indicia, ii) duration of the sale event for each sale item, iii) a price range for each sale item for each sale event, and iv) a frequency distribution which identifies the relationship of the price range and the associated sale items and the associated duration of the associated sales event. The merchant event platform generates a frequency distribution database that utilizes the frequency distribution inputted by the user and which database identifies the price of each sale item during the duration of the associated sales event. The merchant event platform includes at least one online web page configured to display i) at least a portion of each sale item indicia at least during the duration of the sales event for the associated sales item, ii) a price range for an associated sales item for at least the duration of the sales event, iii) a current price for an associated sale item in a sale event, iv) purchasing indicia for an associated sale item in a sale event configured to facilitate consumer purchase of an associated sale item in a sale event, and v) user related advertising indicia associated with the website.

Another aspect of the present invention provides a method of increasing website visibility comprising the steps of: A) providing a user customizable, real-time, online merchant event platform including a user interface and at least one web page; B) inputting by the user through the user interface i) at least one sale item identification indicia, ii) duration of the sale event for each sale item, iii) a price range for each sale item for each sale event, and iii) a frequency distribution which identifies the relationship of the price range and the associated sale items and the associated duration of the associated sales event; C) generating a frequency distribution database by the merchant event platform that utilizes the frequency distribution inputted by the user and which identifies the price of each sale item during the duration of the associated sales event; and D) displaying on the at least one web page i) at least a portion of each sale item indicia at least during the duration of the sales event for the associated sales item, ii) a price range for an associated sales item for at least the duration of the sales event, iii) a current price for an associated sale item in a sale event, iv) purchasing indicia for an associated sale item in a sale event configured to facilitate consumer purchase of an associated sale item in a sale event, and v) user related advertising indicia associated with the website.

The user customizable, real-time, online merchant event platform according to the present invention may further include wherein the frequency distribution includes chronological subsets of the duration of the associated sales events, or unit limits associated with specific price ranges within the price range, or both.

The user customizable, real-time, online merchant event platform according to the present invention may further include displaying the frequency distribution database to the user in the user interface, and wherein the frequency distribution database is selectably editable by the user and wherein the platform will update the frequency distribution database in accordance with the edits by the user and the frequency distribution.

These and other advantages are described in the brief description of the preferred embodiments in which like reference numeral represent like elements throughout.

### BRIEF DESCRIPTION OF THE FIGURES

FIG. 1 is schematic representation of a third party hosted user customizable, real-time, online merchant event platform in accordance with one aspect of the present invention;

FIG. 2 is schematic representation of a user hosted and operated, customizable, real-time, online merchant event platform in accordance with one aspect of the present invention;

FIG. 3 is a schematic representation of a web page portion of the online merchant event platform of FIGS. 1 and 2 that displays information to the consumer in association with one sale event with price variability in accordance with one aspect of the present invention;

FIG. 4 is a schematic representation of user inputs for the online merchant event platform of FIGS. 1 and 2 in accordance with one aspect of the present invention;

FIG. 5 is a schematic representation of a user editable frequency distribution database for the online merchant event platform of FIGS. 1 and 2 in accordance with one aspect of the present invention; and

FIG. 6 is a schematic timeline overview of the method of increasing website visibility utilizing the user customizable, real-time, online merchant event platform of FIGS. 1 and 2 in accordance with one aspect of the present invention.

### DESCRIPTION OF THE PREFERRED EMBODIMENTS

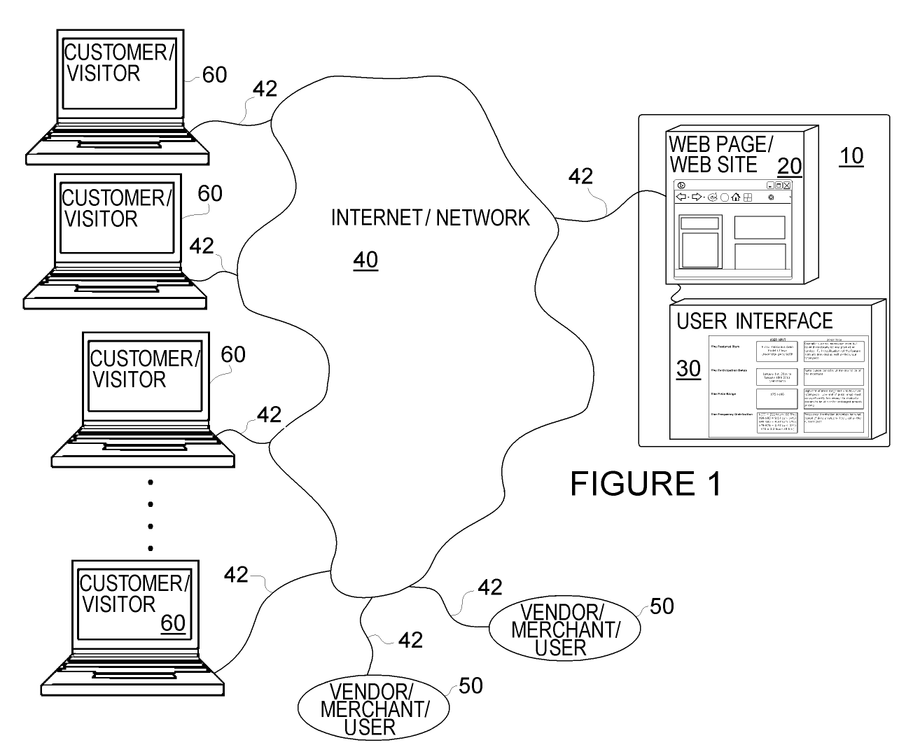

FIG. 1 is schematic representation of a third party hosted and user implemented, user customizable, real-time, online merchant event platform 10 in accordance with one aspect of the present invention in which the platform 10 may be considered as being formed by two components, namely a series of web pages 20 that are accessible by customers 60 (and users 50 or vendors or merchants) and a user interface portion 30 that controls the web pages and which is accessible by the users or vendors or merchants 50. The terms merchants users and vendors are used interchangeably herein and are referenced in the figures as 50. The terms visitors and customers are used interchangeably throughout and are referenced in the figures as 60.

The merchant event platform 10 provides a system for managing marketing promotional events for merchants 50, namely sales events that utilize price variations throughout the duration of the sales event. The platform 10 is an online system as it is implemented through a network such as the internet 40 and will typically be housed on servers (not shown) connected to the network via connections 42. The platform 10 is user customizable in that the users 50 select change and control all of the variables associated with the sales event, as described in greater detail below.

The platform 10 is a real time system in that changes are essentially immediately implemented into the platform 10. More precisely, the time period for the platform 10 to process changes, such as user edits, unit limits reached, new chronological subsets entered, is so brief that these system changes appear to be immediate to the user 50 or customer 60 (or third party operator). The real time aspects of the system allow the platform 10 to handle a dynamic promotional sales event.

As described below, the invention is a system embodied in platform 10 and an associated method to attract visitors or customers 60 to a website, formed by web pages 20 of the system, associated with the vendor 50, and to encourage customers 60 presence at the website 20 of the platform 10 via repeat and prolonged visits, and then encourage visits by customers 60 to either an online, or off-line, merchant location. The platform 10 utilizes a visibly fluctuating price scheme to achieve these goals.

As shown in FIG. 1 user customizable, real-time, online merchant event platform 10 of the present invention may be hosted by a third party (on computer servers not shown) with access to the platform 10 by a plurality of merchant users or vendors 50 via a network, such as the internet 40, and associated conventional internet (or other network) connections 42.

The platform 10 can also operate on any network such as a private area network, to which the vendors or users 50 and the customers 60 have appropriate access. In the third party context the platform 10 can represent a merchant service offered to a variety of users 50, with each user 50 controlling one or more sales events that are implemented through the platform 10 and visible to the customers 60 on the website or web pages 20 of the platform 10.

It is possible that distinct user's sales events may appear on the same web page or pages 20, as an agglomeration of variable price sales events is likely to have a synergistic effect with regard to customer 60 interest. Combining the individual sales events on the web pages 20 represents other issues, such as providing navigation to the customers 60 between the distinct events, or searching among the distinct sales events, that are understood by web page designers and not needed to be described herein in greater detail for a complete understanding of the arrangement and operation of the platform 10.

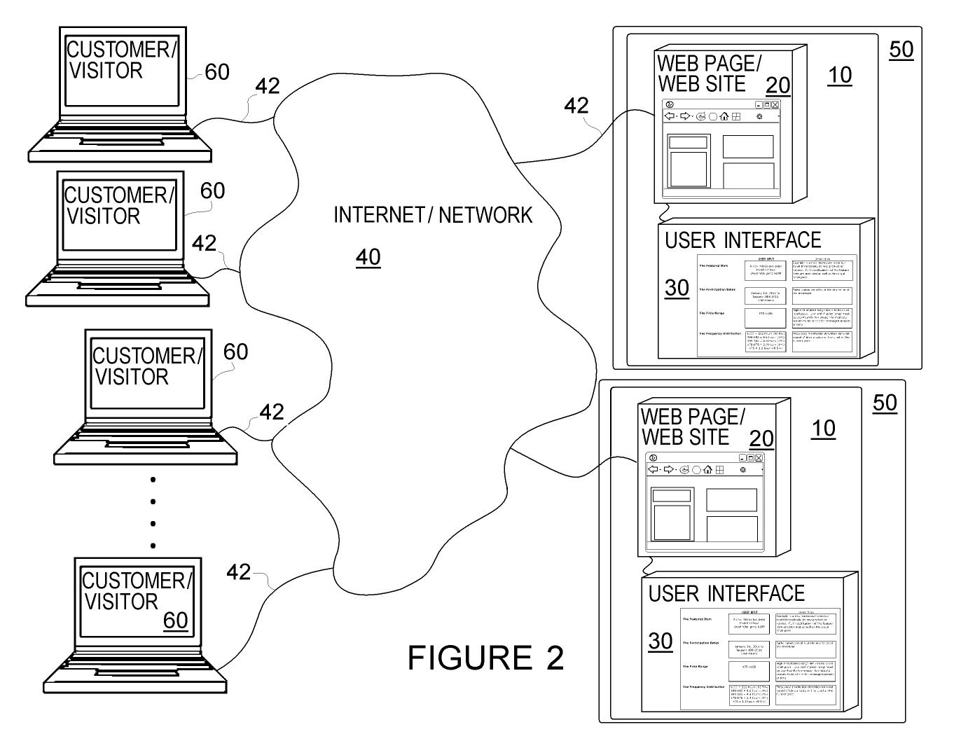

FIG. 2 is schematic representation of a user 50 hosted and operated, customizable, real-time, online merchant event platform 10 in accordance with one aspect of the present invention. Again each platform 10 may be considered as being formed by two components, namely a website formed of at least one and likely a series of web pages 20 that are accessible by customers 60 and a user interface portion 30 that controls the web pages 20 and which is accessible and controllable by the vendors 50. In this implementation each platform 10 is provided to the individual users 50 who host and operate the platform 10 as they desire.

The merchant event platform 10 of FIG. 2 is essentially the same as the third party hosted site of FIG. 1 in that it also provides a system for managing marketing promotional events for merchants or vendors 50, namely promotional sales events that utilize price variations throughout the duration of the sales event. The platform 10 is an online system as it is implemented on a computer through a network such as the internet 40. The main difference between the implementation of FIG. 1 and that of FIG. 2 is that in FIG. 2 the platform 10 will typically be housed on the vendor or user 50 servers (not shown) and connected to the network via connections 42. The platform 10 is again user customizable in that the users 50 select, change and control all of the variables associated with the particular promotional sales events, as described in greater detail below.

Additionally in the implementation of FIG. 2 it is possible that distinct sales events of each vendor 50 may appear on the same web page 20. Again, it is believed that an agglomeration of variable price sales events is likely to have a synergistic effect with regard to customer 60 interest. Further nothing prevents the present invention from being implemented both on third party sites as in FIG. 1 and for other users, directly on their own hosted websites as represented in FIG. 2. Additionally, certain hosting vendors 50 could act as a third party host for other vendors 50 while self hosting their own promotional sales events.

As noted above, the merchant event platform 10 includes an online user interface 30 accessible by the users 50 via either the network 40 in the third party hosted implementation of FIG. 1 or via the user's own computer network in the self hosted implementation of FIG. 2. The user interface 30 is configured to have the user 50 input relevant materials for the user 50 to customize and manage a sales event.

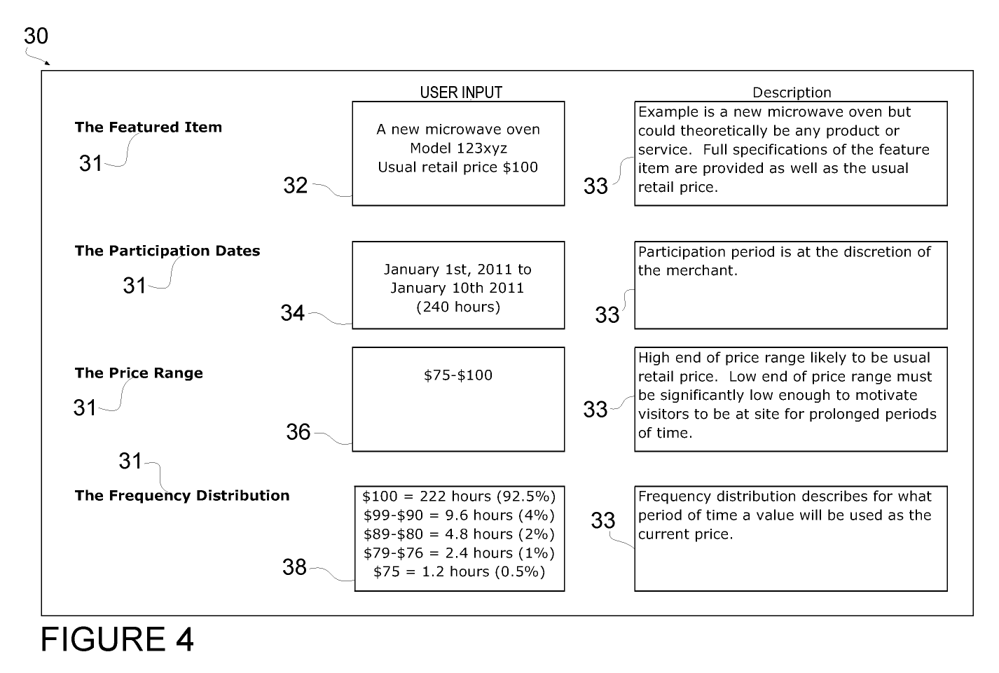

FIG. 4 is a schematic representation of user 50 inputs in a representative user interface 30 for the online merchant event platform 10. As a representative example shown in FIG. 4 the user interface 30 can include a series of user input headings 31 to identify to the user 50 what types of information needs to be entered in selected inputs and may further include and display descriptive texts 33 of the associated inputs. The descriptive texts 33 can further include hypertext links to further explanation for the user 50 of desired inputs, acceptable styles and formatting options, representative examples, historical examples, previous inputs from prior events, suggestions or other input guidelines to assist the user 50, as known in the art. It is intended that the platform 10 be directed to and easily implemented by users 10 that may be skilled retailers but are not necessarily skilled at computer programming or promotional marketing.

The first critical input for the user 50 is sale item identification indicia, shown in input 32 for each sale item to be sold in an associated sales event. The sale item identification indicia input 32 is required to identify the sale items and can include product images, brand names, generic product names, model numbers, model years, retail price, warranty information, product specifications and ratings, slogans, tag lines, performance charts, shipping information, and any other information desired by the user 50. The limitations will namely be those associated with the web page 20 display criteria, the most limiting of which is likely the space available. The sale item identification indicia input 32 can include hyperlinks that will be displayed on the web page 20 to allow customers 60 to selectively obtain further details regarding the particular sale items. Further the user interface 30 can include a distinction between sale item identification indicia inputs 32 that will be displayed to the customer 60 through the web pages 20 and “hidden” sale item identification indicia inputs 32 only viewable to the user 50 through the user interface 30. Finally, the inputs 32 may include a reference or link to allow the platform 10 to “automatically pull” the inputs from another location, such as a company catalog or a previous sales event.

The second critical input for the user 50 is the duration of the sale event for each sale item, with this input 34 being at the discretion of the user 50. Distinct sale items in distinct sale events may be coextensive in the event durations such as being associated with a larger marketing concept, e.g., a “winter blowout sale” on multiple or possibly all user items. Alternatively distinct items in distinct sales events may be run at separate times that may or may not overlap. The inputs 34 may be in a format that is desired to be displayed to the customers 60 on the web pages 20 and can be in any format with the limitations on such inputs will namely be those associated with the web page 20 display criteria (space, formats, etc). The sale event duration input 34 can include hyperlinks that will be displayed on the web page 20 to allow customers 60 to obtain further details regarding the particular promotional sales event. Further the user interface 30 can include a distinction between sale event duration inputs 34 that will be displayed to the customer 60 through the web pages 20 and “hidden” sale event duration inputs 34 only viewable to the user 50 through the user interface 30. Finally, the inputs 34 may include a reference or link to allow the platform 10 to automatically pull the inputs 34 from another location, such as a master sale controlling spreadsheet for coordinating promotional sale events of all distinct items.

The third critical input for the user 50 in managing a promotional price variable sales event through the platform 10 is a price range for each sale item for each sale event, with this input 36 also being at the discretion and control of the user 50. The price range can be entered in a number of formats, such as a simple numerical price range, e.g. $75-$100 as shown in the figures; or a range of discounts used to calculate the final price, e.g. the range is set at 10% to 60% off of the retail price of $100. The price range input 36 could be given as an equation, e.g., the range is set at 10% to (the number of hours of the sale) % off of the (retail price) with all of the associated variable defined for the platform 10. The inputs 36 may be in a format that is desired to be displayed to the customers 60 on the web pages 20 and can be in any format. The price range input 36 can include hyperlinks that will be displayed on the web page 20 to allow customers 60 to obtain further details regarding the price range for this particular sale event. For example the hyperlink may lead the consumer 60 to a text that further defines exactly how the variable price is selected for the duration of the sales event. Further the user interface 30 can include a distinction between price range inputs 36 that will be displayed to the customer 60 through the web pages 20 and “hidden” price range inputs 36 only viewable to the user 50 through the user interface 30. The hidden range inputs may include details relevant to the user 50 for setting or running the sales event. The inputs 36 may also include a reference or link to allow the platform 10 to automatically pull the inputs 36 from another location, such as a master sale controlling spreadsheet for coordinating sale events of all distinct items.

The fourth critical input for the user 50 in managing a price variable sales event through the platform 10 is a frequency distribution input 38 which identifies the relationship of the price range and the associated sale items and the associated duration of the associated sales event with this input 38 again being at the discretion and full control of the user 50 so the user can control the associated sales event. The frequency distribution input 38 can be entered in a number of formats, such as an equation, e.g., the price of the sale item is set at the higher of 10% and (the number of hours remaining in the sale event) % off of the retail price. The frequency distribution inputs 38, when in the equation form, could double as the range inputs, where the price range inputs 36 is effectively the extremes of the equation for the distribution inputs. The equations need not be as simplistic as discussed herein and may not have such a “predictable” pattern from the standpoint of the consumer 60. For example, it may not be desired to have a discount continuously decrease throughout the sale, as consumer interest may wane toward the end of such a sale. The inputs 38 for the frequency distribution may merely be a listing of ranges of prices and percentages of units that are to be sold at that price throughout the sale as shown in the illustration.

The inputs 38 typically would not need to be displayed to the customers 60 but could be if desired by the user 50, and the inputs 38 could have only selected portions viewable on the web pages 20 as with the other inputs. The inputs 38 may also include a reference or link to allow the platform 10 to automatically pull the inputs 38 from another location, such as a master sale controlling spreadsheet for coordinating sales of all distinct items. As noted, the frequency distribution input 38 may be a breakdown of specific sale item prices (or subsets of price ranges) that are associated with chronological subsets of the duration of the associated sales events as shown in FIG. 4.

The frequency distribution gives the user 50 substantial control over the price variable sales event. Additional parameters may be added to provide further control of the event to the user 50 such as the number of chronological subsets the platform 10 may implement in setting up the sales event, or wherein the frequency distribution includes unit limits associated with at least one of the chronological subsets and with specific price ranges within the price range. Consider in the representative example shown in FIG. 4, the $75 price for the microwave sales item may have a listing of running for a total of 1.2 hours (corresponding to 12 six minute chronological subsets) and may further have a unit limit of 10 units at this price. Thus the actual frequency distribution would indicate that the $75 price will be offered for a total of 1.2 hours or until the unit limit in sales at that price is reached in the sales event. Where unit limits are used, then the frequency distribution needs to identify what the distribution moves to if one or more unit limits are hit, e.g., the illustrative rule that if the unit limit of 10 units sold at $75 is hit before the total 1.2 hours of time of the sale event are reached in offering the sale item at this designated price then the remaining time in the sale event in which the sale item would have otherwise been offered at this price, will move offered price to the next highest price range that has not hit its limit, if any. The real time nature of the platform 10 allows unit limits to be easily incorporated into and implemented in a sale event.

The frequency distribution example shown and described is based primarily upon chronological subsets of the duration of the associated sales events, with the possibility of adding unit limits as overrides. The frequency distribution need not be chronologically based other than the overall duration of the event (which in theory actually could also be open ended). For example the frequency distribution may include unit limits associated with specific prices in the price range. As a representative example consider a frequency distribution wherein the price for the first 10 units sold in the sales event is 90% off of the retail price, the next 50 units sold in the sales event is 70% off of the retail price, the next 100 units sold in the sales event is 50% off of the retail price, and every unit sold thereafter in the sales event is 30% off of the retail price. Again the example is intentionally simplistic, as in reality it may be desirable to have a massive discount appear periodically throughout the duration of a sale to peak and maintain consumer interest. The unit limits can include non-numerical restraints, for example adding that only one unit per customer is available at the 90% discount price.

The frequency distribution may include some random aspects to it while still maintaining the control by the user 50. For example customers may be allowed to “roll” a pair of simulated dice (via a random number generator as generally known in the art) at the “check out” to determine the appropriate discount, with the “PAYOUT” listed for the customers e.g. rolling box cars (6 and 6) on the simulated dice generates a 90% retail price reduction while snake eyes (1 and 1) on the simulated dice only generates a 1% retail price reduction. A relatively small number of sales in such a “random” frequency distribution will quickly generate a well known bell curve of results that adds certainty to the overall results for the user 50 as is well understood by marketing professionals whom are skilled in running similar marketing promotions. It is expected the platform 10 will include representative examples of formats for promotional variable price sales events for the user 50 to review and consider, with the user being guided to the various inputs for a selected format. Additionally the platform 10 should be flexible to accept user defined formats for such sales events.

The above inputs 32, 34, 36 and 38 can be through a single input screen as schematically illustrated in FIG. 4. Alternatively an “interview” process may be used in which the platform 10 asks for a series of select questions to elicit all of the items necessary to generate the equivalents of inputs 32, 34, 36 and 38. The interview process is often a method that select software applications utilize when dealing with users whom are less familiar with the implementation of the inputs. The interview process can be helpful to allow unsophisticated users to develop complex inputs including very creative frequency distributions addressing the relevant concerns of the user 50.

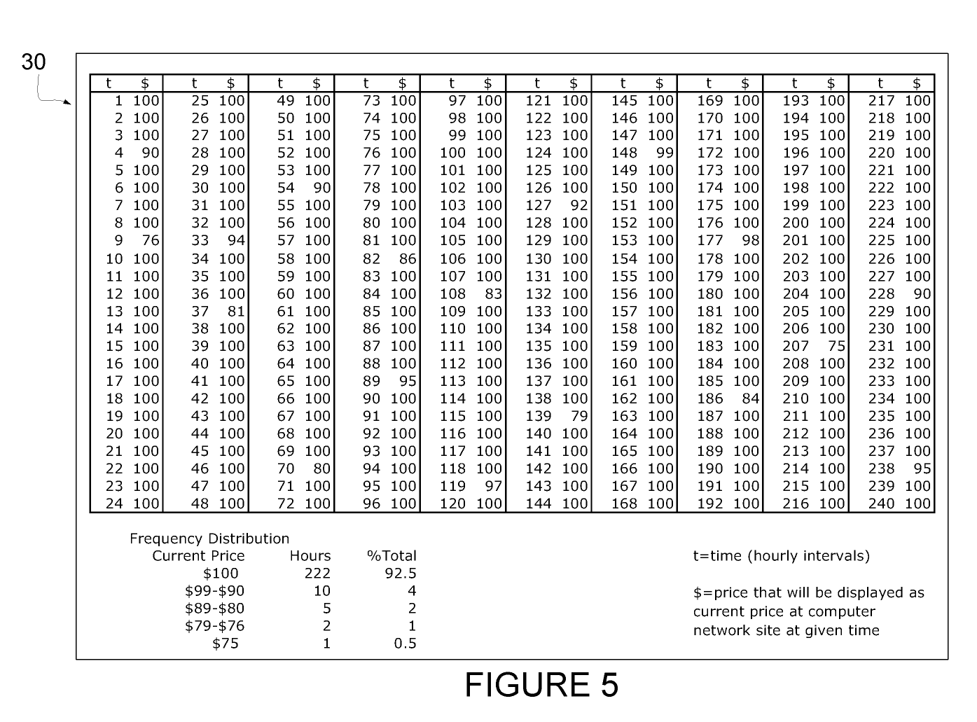

The platform 10 generates a frequency distribution database such as shown in FIG. 5 that utilizes the frequency distribution inputted at 38 by the user 50 and which database identifies the price of each sale item during the duration of the associated sales event. FIG. 5 represents a schematic illustration of the user interface 30 displaying the calculated frequency distribution database to the user 50. In order to provide greater user customization it is anticipated that the frequency distribution database that is shown to the user 50 is selectably editable by the user 50. In the illustrated example the frequency distribution database identified 240 chronological subsets (6 minutes of a 240 hour sale) and has utilized the identified frequency distribution to identify the product price at each chronological subset through a randomized distribution. The editable aspect suggests that the user 50 can identify a given chronological subset (via a mouse click or other known inputting method) and change the given price and wherein the platform will update the frequency distribution database in accordance with the edits by the user 50 and the frequency distribution. For example in the illustrated example the user 50 may identify time 133 and fix the price of the sales item at $75 for that chronological subset of the sales event and can have the platform 10 update the frequency distribution database in accordance with the edits by the user 50. The user 50 may have further control in the update process, such as indicating that only the subsets chronologically after the edited selection should be adjusted by the platform 10. Alternatively, the user may select a number of edits that effectively become fixed points around which the platform 10 generates a revised frequency distribution database. Additionally, the user 50 editing tools for the database may include the ability to swap subsections or chronological subset and other editing tools to simplify expected desired user edits.

Further it is expected the platform 10 will advise the user 50 when edits make it impossible to conform to the frequency distribution. In the illustrated example the platform may inform the user if the edits include a price for a unit in one subset at $70 which is below the price range of the given frequency distribution and thus could not be represented in any valid frequency distribution database (without altering the associated frequency distribution), or if the user 50 identified 17 subsets (more than 1 hour total) that should have the sale items sold at $75 which also could not be represented (without altering the frequency distribution). The display of a user editable frequency distribution database to the user 50 gives a significant amount of user control for the sale event in an easily understood and easily implemented manner.

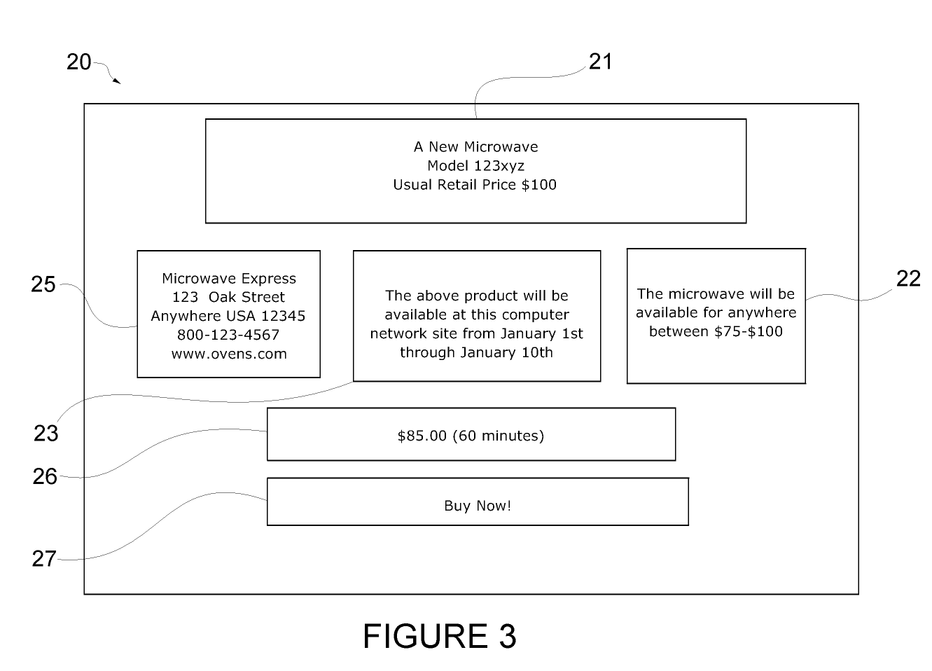

The platform 10 includes at least one online web page 20 which is effectively driven by the user inputs in the user interface 30. FIG. 3 is a schematic representation of a website formed by a web page 20 portion of the online merchant event platform 10 that displays information to the consumers 60 via the network 40. The web page 20 is configured to display at least a portion of each sale item indicia 21 at least during the duration of the sales event for the associated sales item. The displayed indicia 21 are derived from the sale item identification indicia inputs 32 for each sale item to be sold in an associated sales event. The sale item identification indicia 21 represents what the user 50 wants the customers 60 to view relating to sale item identification. The sale item identification display indicia 21 can include, like indicia 32, product images, brand names, generic product names, model numbers, model years, retail price, warranty information, product specifications and ratings, slogans, tag lines, performance charts, shipping information, and any other information desired by the user 50 to be viewed by the customer 60 to identify and describe and market the sales item. Indicia 21 mainly differ from indicia 32 in that “hidden” indicia of indicia 32 will not appear in display indicia 21. The product identifying display indicia 21 need not be grouped together or displayed in any particular manner, just sufficient to allow customers to understand what is being offered.

As the purpose of the variable price sales event is to generate visibility in the website, the web page 20 is configured to display a price range in indicia 22 for an associated sales item for at least the duration of the sales event. The price range display 22 may be a subset of the price range entered by the user in 36, if for example the lowest price in the sales event has already passed in the ongoing sales event the display price range 22 may not include this lowest amount. Alternatively, the illustrated price range 22 may be associated with a subset of items or time, for example price range display 22 could identify that the next 100 units will be sold between $80 and $95 or that the price range of the items sold in the next two hours is between $78 and $93. The price range display 22 can be selected in any manner that the user 50 believes will maximize customer 60 interest in the promotional sales event.

The web page 20 can also display any other indicia 23 as the user deems necessary or helpful for maximizing customer interest and traffic. For example identifying the duration of this particular sales event in indicia 23 as shown. The scope and content of indicia 23 helpful for maximizing customer interest and traffic is essentially limitless and generally known to marketing professionals. The platform can have a number of options available for selection relating to indicia 23, and may include an interview input process to customize a desired type of indicia 23 to a given users sales event.

The web page 20 is configured to display a current price at indicia 26 for an associated sale item in a sale event. The current price in indicia 26 is determined by the frequency distribution and identified in the frequency distribution database. The web page 20 is configured to display purchasing indicia 27 for an associated sale item in a sale event configured to facilitate consumer purchase of an associated sale item in a sale event. The purchasing indicia may be a link to an online checkout or to other system for allowing customers 60 to complete a designated purchase. The details of an online checkout are known to those of ordinary skill in the art. The sale may be completed at the user's physical location and the online portion merely giving the user a receipt to complete such sale.

The goal of the variable price merchant event is to increase website or web page 20 visibility and to utilize the increase traffic at the web page 20 includes user related advertising indicia 25 associated with the website. The indicia 25 may direct the customers 60 to another website, such as the vendors 50 home page particularly where the platform 10 and the web page 20 is a third party hosted implementation as in FIG. 1. The platform 10 thus can increase the web visibility of the web page 20 containing the advertising indicia 25 and of further web pages identified therein. The indicia 25 can appear throughout the web site of the platform 10 formed by web pages 20, and if the web page 20 is hosted by the user 50, such as shown in FIG. 2, the indicia 25 may list further other web pages that are part of the same web site or may not have anything redirecting the customers 60. The indicia 25 may direct the customer 60 to the vendor's brick and mortar store location and/or include other means of customers 60 contacting the user 50. Thus the platform 10 of the present invention can increase the customer traffic online and in brick and mortar locations.

Implementing the platform 10 described above provides a method of increasing website visibility comprising the steps of: A) providing a user 50 customizable, real-time, online merchant event platform 10 including a user interface 30 and at least one web page 20;B) inputting by the user 50 through the user interface 30 i) at least one sale item identification indicia 32, ii) duration of the sale event for each sale item at 34, iii) a price range for each sale item for each sale event at 36, and iv) a frequency distribution at 38 which identifies the relationship of the price range and the associated sale items and the associated duration of the associated sales event; C) generating a frequency distribution database by the merchant event platform 10 that utilizes the frequency distribution inputted by the user 50 and which identifies the price of each sale item during the duration of the associated sales event; and D) displaying on the at least one web page 20 i) at least a portion of each sale item indicia at 21at least during the duration of the sales event for the associated sales item, ii) a price range for an associated sales item at 22 for at least the duration of the sales event, iii) a current price for an associated sale item in a sale event at 26, iv) purchasing indicia for an associated sale item in a sale event at 27 configured to facilitate consumer purchase of an associated sale item in a sale event, and v) user related advertising indicia 25 associated with the website.

As described above the present invention is a computer implemented platform 10 or system and an associated method implemented on the online system designed to attract and maintain visitor presence at a computer network site or website formed by pages 20 and generally encourage visits to a merchant's point of sale (online and or brick and mortar location). The platform 10 utilizes a price frequency distribution and a visible fluctuating price scheme to achieve these goals. The model for a successful long-term internet business has yet to be identified but will most likely be a hybrid of a website and traditional merchants. The present platform 10 utilizes the internet (or other networks) as a far reaching tool to access potential customers and effectively direct them to a merchant's point of sale. The system and associated method described herein encourages customer 60 presence at a computer network site or website, namely web pages 20. Additionally, the system of platform 10 is designed to generally then forward visitors or customers 60 to either an on-line or off-line place of business of the users 50. The platform 10 may thus further help to define the true commercial value of a computer network.

The present invention as described above provides a system that attracts visitors 60 to a computer network site such as web pages 20, encourage presence at the site 20 via repeat and prolonged visits, and then encourage visits by customers 60 to either an on-line, or off-line,(or both) merchant's point of sale. As noted above, the platform 10 utilizes a visibly fluctuating price scheme to achieve these goals and the computer network site formed by web pages 20 may be an internet site on the World Wide Web or a site on an Intranet or local area network or any other computer network.

The network site formed by pages 20 may be accessed by customers 60 by a plurality of technologies including personal or lap top computers, notebooks, desktops, smart phones, PDA's, other hand held devices, kiosks, or any other similar net accessing technologies. Access to the computer network site formed by pages 20 may be provided at any location where the technologies can be accessed including at or near the merchant's physical place of business. As noted above, the retail merchant 50 includes entities that do business on-line, or at a real store location, or both.

The platform 10 as described above is based on a merchant 50 offering at least one item for sale through the computer network site on the platform 10. The merchant 50 chooses a price range for which the merchant 50 is willing to sell the item in this sales event. The computer network site formed by pages 20 will display a current price at indicia 26 for the item, and may include other information in this indicia such as how much longer a given price will be available. The current price will fluctuate throughout the duration of the sale event, either randomly or on a schedule provided by the merchant 50, within the price range provided by the merchant 50 and in accordance with the frequency distribution provided by the vendor or merchant 50.

As described above the current price at any time period will be derived from a frequency distribution provided by the merchant 50. The frequency distribution may, for example define the period of time, based on a percentage of the entire participation period or sale event duration, that each value in the price range will serve as the current price. The current price will typically more often be near the high end of the price range and less often in the low end of the price range. The timing of the current price change as well as the time spent in each segment of the price range may be unknown to a computer network site visitor 60.

As should be clear from the above description, it is the anticipation of infrequent low prices, and the uncertainty as to when they will occur, that will attract and maintain visitor presence at the computer network site 20. The merchant 50 may provide information, either at their place of business or via electronic technology that will assist a visitor in being present at the computer network site 20 during a time when the current price is low. In addition, to realize a savings afforded through the computer network site 20 the visitor or customer 60 will be required to visit the merchant's point of sale thus driving traffic to the merchant 50.

In review the user 50 begins to implement the platform 10 by having the merchant identifying through the user interface a featured item (product or service) that they will offer for sale event at the computer network site 20 that is hosting the platform 10. In addition, the merchant 50 will be required to provide to the hosting site (third party or his own site): the duration for which the featured item will be for sale (also identified as the duration of the sale event or “the participation period”, a price range for which they are willing to sell the featured item, and c) a frequency distribution that describes the fluctuation of the price within the predetermined range over the participation time. This frequency distribution may, for example, dictate the amount of time, as a percentage of the participation period, which each value within the provided price range will be displayed as the current price.

It may be important to maximize customer interest if a range includes a low value that is appealing to a consumer 60 who desires to purchase the item. For the platform to work most effectively the price for the item will be most often in the high end of the provided range. A visitor will then be motivated to wait at the site, or return to the site often, in order to be present when the price is at the low end of the provided range. The platform 10 collects the above information from the merchant. The price range, the participation period, and the frequency distribution provided by the merchant are then used to create the fluctuating current price scheme also identified as the frequency distribution database. The participation period or sales duration may be divided into smaller units of time (chronological subsets) and the price range comprises price values. The frequency distribution can define how often, as a percentage of the total participation period, that the current price will be represented by each price value. The fluctuating price scheme will automatically in real time change the current price of the item, visible at the website, at either a predetermined or random time interval.

The merchant will be given large amounts of control over the process in that they are allowed to control the price fluctuation, and thus the current price, within the parameters established by the initial information provided. At the website the featured item is displayed with all necessary information including the featured item specifications, the merchant demographic data, the price range, the participation period, the fluctuating current price, and a button that will allow the visitor to purchase the item at the current price. One embodiment of the present invention also allows for additional information to be visible at the computer network site including, but not limited to, the time of the next current price change as well as the history of the current price. This information would theoretically define a time period when visitor presence at the website would be anticipated to be high. In addition, visitors would be aware of the likelihood of obtaining a low price during the remainder of the campaign. Another embodiment of the method allows for this information to be provided to a visitor at the merchant's place of business or via electronic communication. This would encourage traffic at the merchant's business. Lastly, there will be a purchase button in close proximity that will allow a visitor to purchase the item at any time.

In one implementation of the present invention a visitor may come to the computer network site 20 and may provide basic demographic information. Additionally, for combined sales events on the website 20 they may search the site by geographic location, by merchant, or by featured items. As they locate an item that they may wish to purchase, the visitor will see, for example, a picture of the item with specifications, the dates during which the item will be for sale at the website, the price range in which the merchant is willing to sell the item, and the current price as determined by the fluctuating price scheme. In that the current price of the item will most often be in the high end of the range provided by the merchant, it is likely that the visitor will not initially purchase the item. Rather they will be motivated to wait until the current price is closer to the low end of the price range. The fluctuating price scheme will generate a changing current price at the discretion and control of the participating merchant. A new current price may be generated on some fixed time period or alternatively may occur randomly.

The merchant 50 may also be given the opportunity to manipulate the current price on a real time basis. The visitor may receive information from the merchant, either directly at the merchant's place of business or via electronic communication that would encourage more visits to the computer network site. This information may include the schedule for changes for the current price or any additional information that would motivate additional visits to the computer network site.

In one easily implemented embodiment, when the current price is acceptable to the visitor 60 to make a purchase, they will click a purchase button 27. The button 27 may generate a confirmation email that will contain the visitor's demographic data, the current price that they will be allowed to purchase the item for, and a unique security code. For on-line purchases, the visitor will be forwarded to the merchant's website or other online checkout method. When completing the purchase they may be asked to enter the unique security code to complete the transaction. For off-line purchases the visitor 60 may be asked to take the email confirmation to the merchant's place of business. Matching visitor demographic data and the unique security code will minimize improprieties. Only one purchase will be allowed per demographic-security code pair.

As described above FIG. 5 is an example of the frequency distribution database from which the current price is generated. In this example, the merchant has chosen a 10-day period for the participation period and a price range of $75-100. The frequency distribution created by the merchant 50 is shown at the bottom of the figure. In this example, the merchant has requested that for 92.5% of the participation period (222 hours) the current price will be displayed as $100 and that for 0.5% of the participation dates the current price will be displayed as $75. The shaded columns labeled “t” represent the 240 hours of the participation period. Any time interval may be utilized for the chronological subsets and they need not be equal in length. The values in the non-shaded columns labeled “$” represent the current price that would be displayed at the computer network site 20 at each time interval. The current price may be inserted into a time block randomly or based on a predetermined plan as designed by the merchant.

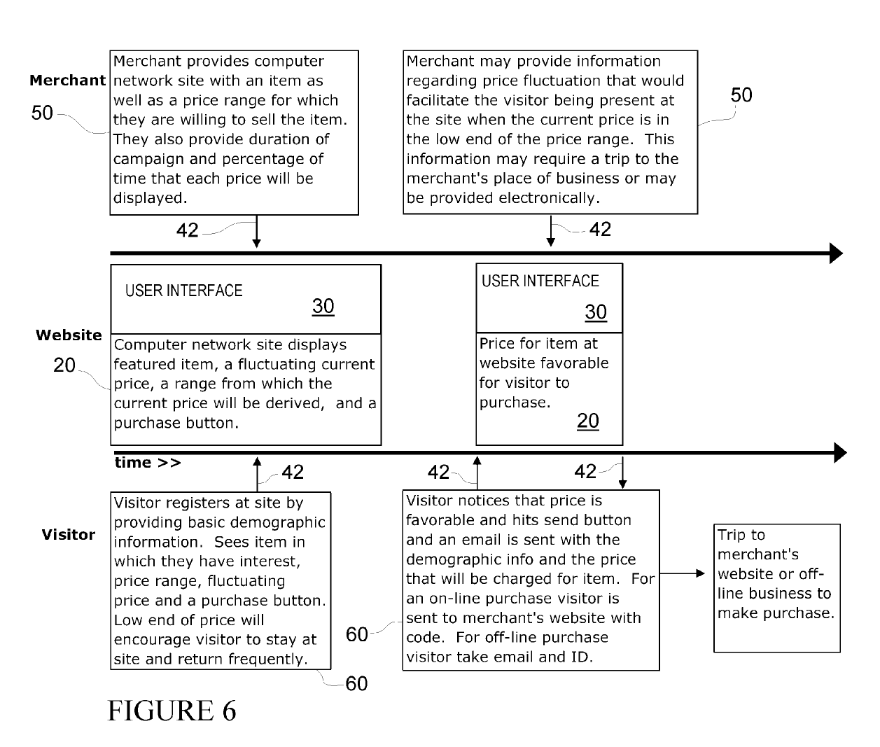

FIG. 6 demonstrates a general timeline overview of the platform and associated method of the present invention. The two large arrows moving left to right represent time. The method begins with a participating merchant identifying a featured item that they offer for sale through the computer network site 20. The merchant 50 provides, through the user interface 30, the site 20 with information that includes: a description of the item, the participation period, the price range for which the item will be offered for sale, and the frequency distribution. The frequency distribution may define the amount of time, as a percentage of the participation dates, that each value within the given price range will be displayed as the current price of the item. The information from the merchant is then displayed at the computer network site 20. Each featured item will be displayed along with demographic information from the merchant 59, the price range from which the current price will be derived, and the current price of the item. The current price of the item displayed at the computer network site, as derived from the frequency distribution, will fluctuate at intervals based on a schedule determined by the participating merchant. This change may be random. A purchase button for the visitor to buy the item, if they find the current price acceptable will be visible at the site. A visitor to the site becomes interested in the process. The visitor may be required to establish an account by providing some basic demographic information. The visitor may then search the site based on a number of criteria including, but not limited to, the geographic location of the merchant, feature item, and online vs. off-line merchant. The visitor will find an item that they desire to purchase. They will see a full description of the item, the range within which the merchant is willing to sell the item, and the current price.

Based on the frequency distribution, it is likely that the visitor will be at the site at a time when the current price is in the high end of the range. Realizing the likelihood of getting a better price, the visitor is likely to wait at the computer network site and observe the output of the fluctuating price scheme. It is also likely that based on the timing of current price fluctuation the visitor will make frequent stops to the computer network site to assess the current price for the item. The merchant may wish to provide additional information regarding the process. For example, in the case of a randomly fluctuating current price the merchant may wish to provide information as to when the next price fluctuation may occur. This would facilitate visitor presence at the site during a specified time period that could then be used to direct messages to a specific audience. In addition, the merchant may wish to provide information regarding the price fluctuation at their place of business or via electronic communication. This would encourage visits to the place of business. The current price of the item displayed at the computer network site will depend on the frequency distribution and the schedule provided by the merchant. In the figure the fluctuating price scheme has displayed a price that favors a purchase. The visitor sees the low current price and purchases the item by clicking on the purchase button. When the current price is acceptable to the visitor to make a purchase, they will click a purchase button. The button may, for example, generate a confirmation email that will contain the visitor's demographic data, the current price that they will be allowed to purchase the item for, and a unique security code. For on-line purchases, the visitor may be forwarded to the merchant's website. When completing the purchase they may be asked to enter the code to complete the transaction. For off-line purchases the visitor may be asked to take the email confirmation to the merchant's place of business. Matching visitor demographic data and unique security code will minimize improprieties. Only one purchase will be allowed per demographic-pass code pair.

The preferred embodiments described above are illustrative of the present invention and not restrictive hereof. It will be obvious that various changes may be made to the present invention without departing from the spirit and scope of the invention. The precise scope of the present invention is defined by the appended claims and equivalents thereto.

What is claimed is:

1. A user customizable, real-time, online merchant event platform utilizing price variations for at least one sales event for increasing website visibility comprising:
A) An online user interface accessible by the user, wherein the user interface is configured to have the user input at least:
i) At least one sale item identification indicia,
ii) Duration of the sale event for each sale item,
iii) A price range for each sale item for each sale event, and
iv) A frequency distribution which identifies the relationship of the price range and the associated sale items and the associated duration of the associated sales event;
B) A frequency distribution database generated by the merchant event platform that utilizes the frequency distribution inputted by the user that identifies the price of each sale item during the duration of the associated sales event; and
C) At least one online web page configured to display
i) At least a portion of each sale item indicia at least during the duration of the sales event for the associated sales item,
ii) A price range for an associated sales item for at least the duration of the sales event,
iii) A current price for an associated sale item in a sale event,
iv) purchasing indicia for an associated sale item in a sale event configured to facilitate consumer purchase of an associated sale item in a sale event, and
v) user related advertising indicia associated with the website.

2. The user customizable, real-time, online merchant event platform according to claim 1 wherein the frequency distribution includes chronological subsets of the duration of the associated sales events.

3. The user customizable, real-time, online merchant event platform according to claim 2 further including displaying the frequency distribution database to the user in the user interface.

4. The user customizable, real-time, online merchant event platform according to claim 3 wherein the frequency distribution database is selectably editable by the user and wherein the platform will update the frequency distribution database in accordance with the edits by the user and the frequency distribution.

5. The user customizable, real-time, online merchant event platform according to claim 3 wherein the frequency distribution includes unit limits associated with at least one of the chronological subsets and with specific price ranges within the price range.

6. The user customizable, real-time, online merchant event platform according to claim 1 further including displaying the frequency distribution database to the user in the user interface.

7. The user customizable, real-time, online merchant event platform according to claim 6 wherein the frequency distribution database is selectably editable by the user and wherein the platform will update the frequency distribution database in accordance with the edits by the user and the frequency distribution.

8. The user customizable, real-time, online merchant event platform according to claim 7 wherein the frequency distribution includes unit limits associated with at least one of the chronological subsets and with specific price ranges within the price range.

9. The user customizable, real-time, online merchant event platform according to claim 1 wherein the frequency distribution includes unit limits associated with specific prices in the price range.

10. The user customizable, real-time, online merchant event platform according to claim 9 further including displaying the frequency distribution database to the user in the user interface.

11. The user customizable, real-time, online merchant event platform according to claim 10 wherein the frequency distribution database is selectably editable by the user and wherein the platform will update the frequency distribution database in accordance with the edits by the user and the frequency distribution.

12. A method of increasing website visibility comprising the steps of:
A) Providing a user customizable, real-time, online merchant event platform including a user interface and at least one web page;
B) Inputting by the user through the user interface
i) At least one sale item identification indicia,
ii) Duration of the sale event for each sale item,
iii) A price range for each sale item for each sale event, and
iv) A frequency distribution which identifies the relationship of the price range and the associated sale items and the associated duration of the associated sales event;
C) Generating a frequency distribution database by the merchant event platform that utilizes the frequency distribution inputted by the user and which identifies the price of each sale item during the duration of the associated sales event; and
D) Displaying on the at least one web page
i) At least a portion of each sale item indicia at least during the duration of the sales event for the associated sales item,
ii) A price range for an associated sales item for at least the duration of the sales event,
iii) A current price for an associated sale item in a sale event,
iv) purchasing indicia for an associated sale item in a sale event configured to facilitate consumer purchase of an associated sale item in a sale event, and
v) user related advertising indicia associated with the website.

13. The method of increasing website visibility according to claim 12 wherein the frequency distribution includes chronological subsets of the duration of the associated sales events.

14. The method of increasing website visibility according to claim 13 further including the step of displaying the frequency distribution database to the user in the user interface.

15. The method of increasing website visibility according to claim 14 wherein the frequency distribution database is selectably editable by the user and further including the step of updating in real time the frequency distribution database in accordance with the edits by the user and the frequency distribution.

16. The method of increasing website visibility according to claim 12 wherein the frequency distribution includes unit limits associated with specific prices in the price range.

17. The method of increasing website visibility according to claim 16 further including the step of displaying the frequency distribution database to the user in the user interface.

18. The method of increasing website visibility according to claim 17 wherein the frequency distribution database is selectably editable by the user and further including the step of updating in real time the frequency distribution database in accordance with the edits by the user and the frequency distribution.

19. The method of increasing website visibility according to claim 12 further including the step of displaying the frequency distribution database to the user in the user interface.

20. The method of increasing website visibility according to claim 19 wherein the frequency distribution database is selectably editable by the user and further including the step of updating in real time the frequency distribution database in accordance with the edits by the user and the frequency distribution.
